(19) United States
(12) Patent Application Publication
(10) Pub. No.: US 2006/0280433 A1
(43) Pub. Date: Dec. 14, 2006

(54) Distributed media recording module system processes

(76) Inventor: David Charles Cain, Richardson, TX (US)

Correspondence Address: David Cain, 1333 W. Campbell Rd., Suite 143, Richardson, TX, 75080, US

(21) Appl. No.: 11/153,564

(22) Filed: Jun. 14, 2005

(51) Int. Cl. H04N 5/91

(52) U.S. Cl. 386/83

(57) ABSTRACT

A method of selecting broadcast recordings for playback on a personal video recorder interface may be performed by receiving broadcast recordings at a personal video recorder module and storing said broadcast recordings on a system memory device. A data file is created including information regarding said broadcast recordings and stored on said system memory device. A user may request the data file from the system memory device at the personal video recorder interface module. Selected broadcast recordings from said data file may be displayed.

### TECHNICAL FIELD OF THE INVENTION

The invention relates to the field of media management systems.

### BACKGROUND OF THE INVENTION

As the living space of modern homes become networked, the ability to centralize some resources while providing dispersed rendering devices has become key.

What is needed, therefore, is a personal video recorder system providing an interface module capable of accessing networked resources.

### SUMMARY OF THE INVENTION

A method of selecting broadcast recordings for playback on a personal video recorder interface may be performed by receiving broadcast recordings at a personal video recorder module and storing said broadcast recordings on a system memory device. A data file is created including information regarding said broadcast recordings and stored on said system memory device. A user may request the data file from the system memory device at the personal video recorder interface module. Selected broadcast recordings from said data file may be displayed.

### BRIEF DESCRIPTION OF THE DRAWINGS

For a more complete understanding of the present invention and the advantages thereof, reference is now made to the following description taken in conjunction with the accompanying Drawings in which:

FIG. 1 illustrates a conditional access module;

FIG. 2 illustrates a display network content process;

FIG. 3 illustrates a media recorder interface module system;

FIG. 4 illustrates a media recorder;

FIG. 5 illustrates an MPEG encoder;

FIG. 6 illustrates a video distribution system;

FIG. 7 illustrates a media interface module system;

FIG. 8 illustrates a media interface module system playback process;

FIG. 9 illustrates a recorded video distribution system;

FIG. 10 illustrates a media interface module system recording process;

FIG. 11 illustrates a media recorder interface module;

FIG. 12 illustrates a media recorder;

FIG. 13 illustrates an MPEG decoder;

FIG. 14 illustrates a display network content process; and

FIG. 15 illustrates a power grid content sharing process.

### DETAILED DESCRIPTION OF THE INVENTION

Referring now to the drawings, wherein like reference numbers are used to designate like elements throughout the various views, several embodiments of the present invention are further described. The figures are not necessarily drawn to scale, and in some instances the drawings have been exaggerated or simplified for illustrative purposes only. One of ordinary skill in the art will appreciate the many possible applications and variations of the present invention based on the following examples of possible embodiments. The disclosed systems, components and processes contemplate substitution and combination of the disclosed systems, components and processes, even where the substitutions and combinations are not expressly disclosed.

As used herein, “programs” include news shows, sitcoms, comedies, movies, commercials, talk shows, sporting events, on-demand videos, and any other form of television-based entertainment and information. Further, “recorded programs” include any of the aforementioned “programs” that have been recorded and that are maintained with a memory component as recorded programs, or that are maintained with a remote program data store. The “recorded programs” can also include any of the aforementioned “programs” that have been recorded and that are maintained at a broadcast center and/or at a head-end that distributes the recorded programs to subscriber sites and client devices.

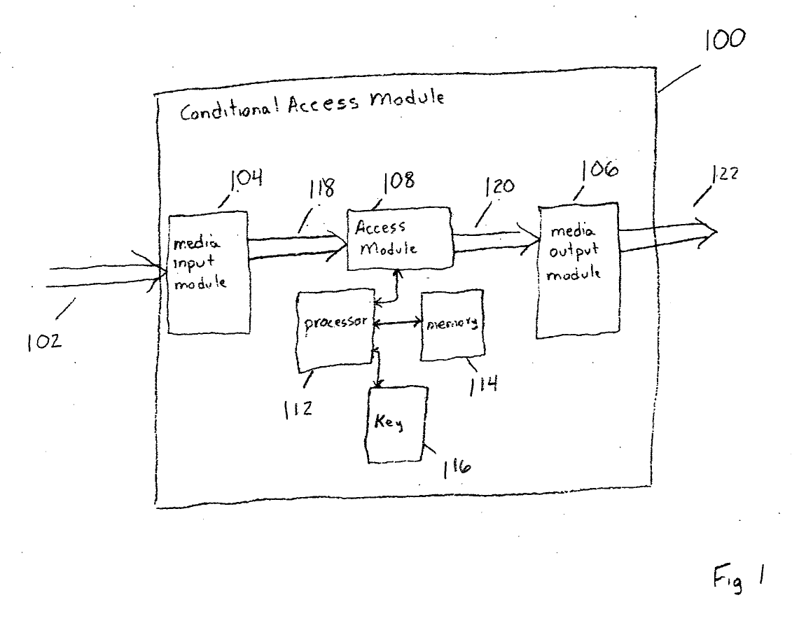

With reference to FIG. 1, a conditional access module 100 is shown. The conditional access module 100 receives a media signal 102 including an encoded media signal 118 at a media input module 104. An access module 108 receives the encoded media signal 118. If access to the media content represented by the encoded media signal 118 is authorized, the access module 108 decodes the encoded media signal 118 to generate decoded media signal 120. The decoded media signal 120 is delivered to a media output module 106 for further processing and distribution of output media signal 122.

Conventional networking technologies may be used to facilitate the communications among the various systems. For example, the network communications may implement the Transmission Control Protocol/Internet Protocol (TCP/IP), and additional conventional higher-level protocols, such as the Hyper Text Transfer Protocol (HTTP) or File Transfer Protocol (FTP). Connection of media recorders to communication networks may allow the connected media recorders to share recorded content, utilize centralized or decentralized data storage and processing, respond to control signals from remote locations, periodically update local resources, provide access to network content providers, or enable other functions.

The access decision made by the access module 108 may be enacted, enforced or determined in conjunction with access processor 112. Access processor 112 typically executes applications, reads and stores data, and other necessary or desired functions of access memory 114. An access key input module 116 may accept user input or mechanical input such as a smartcard as an authentication input to access processor 112.

The various communication networks employed may be implemented with different types of networks or portions of a network. The different network types may include: the conventional POTS telephone network, the Internet network, World Wide Web (WWW) network or any other suitable communication network. The POTS telephone network is a switched-circuit network that connects a client to a point of presence (POP) node or directly to a private server. The POP node and the private server connect the client to the Internet network, which is a packet-switched network using a transmission control protocol/Internet protocol (TCP/IP). The World Wide Web (WWW) network uses a hypertext transfer protocol (HTTP) and is implemented within the Internet network and supported by hypertext mark-up language (HTML) servers.

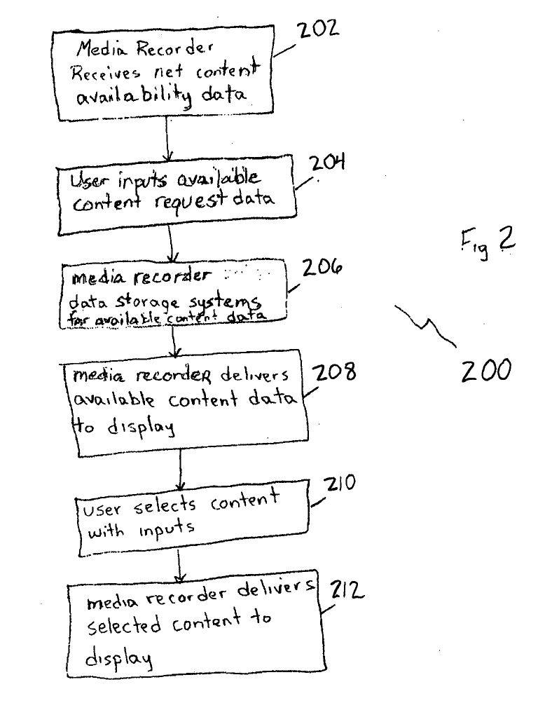

With reference to FIG. 2, a process of displaying stored network content using a media recorder 200 is shown. A media recorder receives network content availability data from data storage systems, like personal computers, on the network at function block 202. A user inputs a request for available content at function block 204. The media recorder may poll the data storage systems for updated network content availability data at function block 206. The media recorder delivers the available content data to a display at function block 208. The user selects content using user inputs at function block 210. The media recorder delivers the selected content to a display at function block 212.

Communications networks may be, include or interface to any one or more of, for instance, a cable network, a satellite television network, a broadcast television network, a telephone network, an open network such as the Internet, an intranet, a local area network (LAN), a wide area network (WAN), a metropolitan area network (MAN), a storage area network (SAN), a frame relay connection, an Advanced Intelligent Network (AIN) connection, a synchronous optical network (SONET) connection, a digital T1, T3, E1 or E3 line, Digital Data Service (DDS) connection, an ATM (Asynchronous Transfer Mode) connection, an FDDI (Fiber Distributed Data Interface), CDDI (Copper Distributed Data Interface) or other wired, wireless or optical connection.

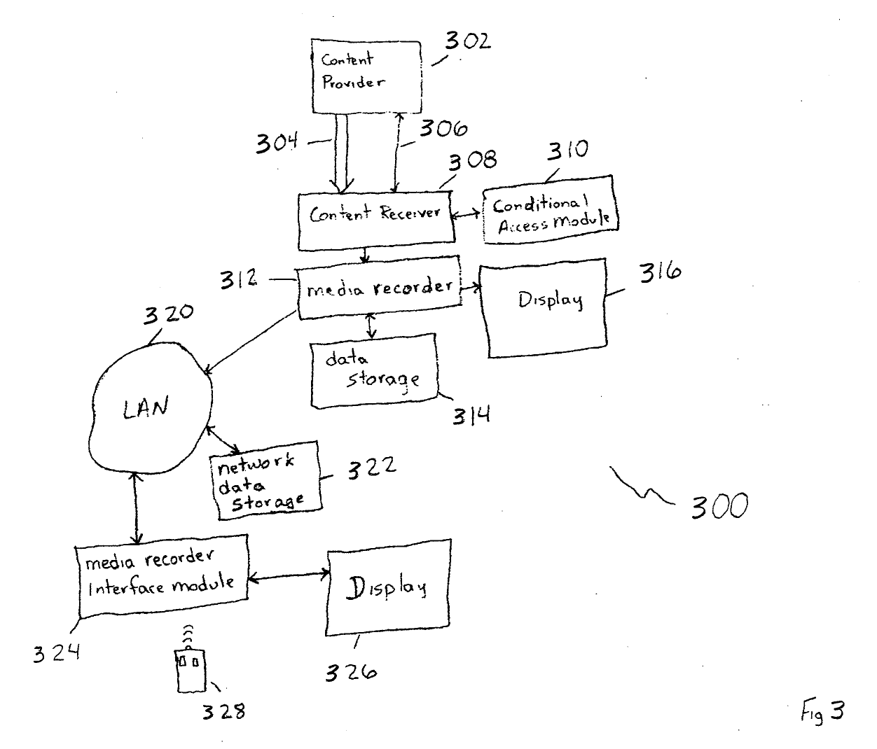

With reference to FIG. 3, a block diagram of a distributed media system 300 including a media recording interface module 324 is shown. A content receiver 308 receives content signal streams from a content provider 302 over a communication network 304. The content receiver 308 may communicate with content provider 302 using a backchannel 306 such as a telephone connection, network connection or any other appropriate communication channel.

In embodiments, communications networks may include a comparatively high-capacity backbone link, such as a fiber optic or other link, connecting to a content provider, for transmission over which a carrier or other entity impose a per-megabyte or other metered or tariffed cost. A typical home network may be compatible with a high speed wired or wireless networking standard (e.g., Ethernet, HomePNA, 802.11a, 802.11b, 802.11g, 802.11g over coax, IEEE1394, etc.) although non-standard networking technologies may also be employed such as is currently available from companies such as Magis, FireMedia, and Xtreme Spectrum. A plurality of networking technologies may be employed with a network bridge as known in the art.

A backchannel 306 is often used when communication system 304 is unidirectional, such as in a satellite broadcast system. Content receiver 308 may be connected to or otherwise implement a conditional access module 310. Conditional access module 310 determines authorization and decodes encoded media signals accordingly. The content receiver 304 provides content signal streams to a media recorder 312. The media recorder 312 may store the media signals to data storage 314.

A wired networking technology (e.g., Ethernet) may be used to connect fixed location devices, while a wireless networking technology (e.g., 802.11g) may be used to connect mobile devices. The media server may be also capable of being a receiving device for audio visual information and interfacing to a legacy device television. Networks that consolidate and distribute audiovisual information are also well known. Satellite and cable-based communication networks broadcast a significant amount of audio and audiovisual content.

The media recorder may deliver media signals to display 316 for viewing. A local area network 320 may connect the content receiver 314 and the media recorder 318 as well as other local devices. The media recorder 318 may record media content on network data storage 322. A media recorder interface module 324 may be connected to the media recorder and network data storage 322 through the local area network 320.

Further, these networks also may be constructed to provide programming on demand, e.g., video-on-demand. In these environments a signal is broadcast, multicast, or unicast via a servicing network, and a set top box local to a delivery point receives, demodulates, and decodes the signal and places the audiovisual content into an appropriate format for playing on a delivery device, e.g., monitor and audio system. Recording of the audiovisual information for later playback has been recently introduced as an option for set-top-boxes. In such case, the set top box may include a hard drive that stores encoded audiovisual information for later playback.

The media recorder interface module 324 may deliver media content to display 326 for viewing. User inputs may be received using a user input system 328, such as an I/R remote control. The user inputs may be guided by a graphic interface shown on display 326. The media recorder 312 receives content signal streams from the content receiver 308. The media recorder 312, in response to user input programming selections or other programmed instructions, records selected content signal streams on local data storage 318 or on network data storage 322.

As used herein and in the appended claims, the term “display” will be understood to refer broadly to any video monitor or display device capable of displaying still or motion pictures including but not limited to a television. The term “audiovisual device” will be understood to refer broadly to any device that processes video and/or audio data including, but not limited to, television sets, computers, camcorders, set-top boxes, Personal Video Recorders (PVRs), video cassette recorders, digital cameras and the like. The term “audiovisual programming” will refer to any programming that can be displayed and viewed on a television set or other display device, including motion or still pictures with or without an accompanying audio soundtrack. “Audiovisual programming” will also be defined to include audio programming with no accompanying video that can be played for a listener using a sound system of the television set or entertainment system.

Local data storage 318 may be directly connected to the media recorder 302 or integrated therewith. Network data storage 322 may be a data storage device or may be data storage integrated with other networked components. The media recorder interface module 324 typically does not include local data storage.

Audiovisual programming can be in any of several forms including, data recorded on a recording medium, an electronic signal being transmitted to or between system components or content being displayed on a television set or other display device. The various described components may be represented as modules comprising logic embodied in hardware or firmware. A collection of software instructions written in a programming language, such as, for example C++. A software module may be compiled and linked into an executable program, installed in a dynamic link library, or may be written in an interpretive language such as BASIC. It will be appreciated that software modules may be callable from other modules or from themselves, and/or may be invoked in response to detected events or interrupts.

When an available content list is requested from the media recorder interface module 324, the media recorder interface module 324 polls the data storage systems on the local area network 320 for a current list of available content. Instructions for programming recording or other system instructions may be passed from the media recorder interface module 324 to the media recorder 312 for processing.

Software instructions may be embedded in firmware, such as an EPROM or EEPROM. It will be further appreciated that hardware modules may be comprised of connected logic units, such as gates and flip-flops, and/or may be comprised of programmable units, such as programmable gate arrays or processors. For example, in one embodiment, the functions of the compositor device 12 may be implemented in whole or in part by a personal computer or other like device. It is also contemplated that the various described components need not be integrated into a single box. The components may be separated into several sub-components or may be separated into different devices that reside at different locations and that communicate with each other, such as through a wired or wireless network, or the Internet. Multiple components may be combined into a single component.

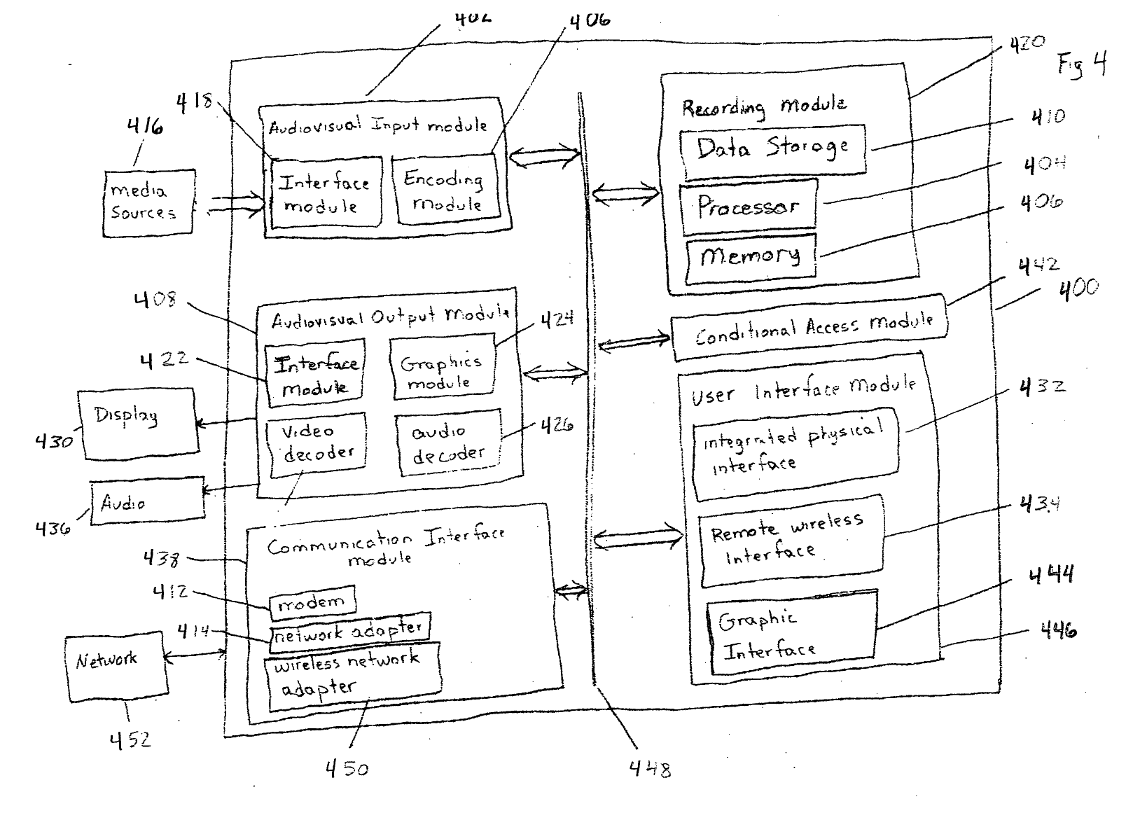

With reference to FIG. 4, a media recorder 400 in accordance with a disclosed embodiment is shown. The media recorder 400 may include an audiovisual input module 402. The audiovisual input module 402 may receive media signals from a content provider 416 or other media sources. The media recorder may include an audiovisual output module 408. The audiovisual output module 408 may output media signals to a display 430, an audio rendering device 436 or other appropriate output devices.

It is also contemplated that the components described herein may be integrated into a fewer number of modules. One module may also be separated into multiple modules. As used herein, “high resolution” may be characterized as a video resolution that is greater than standard NTSC or PAL resolutions. Therefore, in one embodiment the disclosed systems and methods may be implemented to provide a resolution greater than standard NTSC and standard PAL resolutions, or greater than 720×576 pixels (414,720 pixels, or greater), across a standard composite video analog interface such as standard coaxial cable.

The media signals may be processed, stored or transferred by a media recording module 420 including a media recorder processor 404 and processing memory 406. Data storage medium 410 is typically used to stored the recorded media data. The media recorder 400 may communicate with other components or systems either directly or through a network 452 with a communication interface module 438. The communication interface module 438 may implement a modem 412, network interface 414, wireless interface 450 or any other suitable communication interface. The elements of the media recorder 400 may be interconnected by a conventional bus architecture 448.

Examples of some common high resolution dimensions include, but are not limited to: 800×600, 852×640, 1024×768, 1280×720, 1280×960, 1280×1024, 1440×1050, 1440×1080, 1600×1200, 1920×1080, and 2048×2048. In another embodiment, the disclosed systems and methods may be implemented to provide a resolution greater than about 800×600 pixels (i.e., 480,000 pixels), alternatively to provide a resolution greater than about 1024×768 pixels, and further alternatively to provide HDTV resolutions of 1280×720 or 1920×1080 across a standard composite video analog interface such as standard coaxial cable. Examples of high definition standards of 800×600 or greater that may be so implemented in certain embodiments of the disclosed systems and methods include, but are not limited to, consumer and PC-based digital imaging standards such as SVGA, XGA, SXGA, etc.

Generally, the processor 404 executes instructions such as those stored in processing memory 408 to provide functionality. Processing memory 408 may include dynamic memory devices such as RAM or static memory devices such as ROM and/or EEPROM. The processing memory 408 may store instructions for boot up sequences, system functionality updates, or other information. Communication interface module 438 may include a network interface 414. The network interface 414 may be any conventional network adapter system.

It will be understood that the forgoing examples are representative of exemplary embodiments only and that the disclosed systems and methods may be implemented to provide enhanced resolution that is greater than the native or standard resolution capability of a given video system, regardless of the particular combination of image source resolution and type of interface. Media content may be delivered to homes via cable networks, satellite, terrestrial, and the Internet. The content may encrypted or otherwise scrambled prior to distribution to prevent unauthorized access. Conditional access systems reside with subscribers to decrypt the content when the content is delivered.

Typically, network interface 414 may allow connection to an Ethernet network 452. The network interface 414 may connect to a home network, to a broadband connection to a WAN such as the Internet or any of various alternative communication connections. Communication interface module 438 may include a wireless network interface 450.

Media systems implement conditional access policies that specify when and what content the viewers are permitted to view based on their subscription package or other conditions. In this manner, the conditional access systems ensure that only authorized subscribers are able to view the content. Conditional access systems may support remote control of the conditional access policies. This allows content providers to change access conditions for any reason, such as when the viewer modifies subscription packages. Conditional access systems may be implemented as a hardware based system, a software based system, a smartcard based system, or hybrids of these systems. In the hardware based systems, the decryption technologies and conditional policies are implemented using physical devices.

Typically, wireless network interface 450 permits the media recorder to connect to a wireless communication network. A user interface module 446 provides user interface functions. The user interface module 446 may include integrated physical interfaces 432 to provide communication with input devices such as keyboards, touch-screens, card readers or other interface mechanisms connected to the media recorder 400.

The hardware-centric design is considered reasonably reliable from a security standpoint, because the physical mechanisms can be structured so that they are difficult to attack. However, the hardware solution has drawbacks in that the systems may not be easily serviced or upgraded and the conditional access policies are not easily renewable. Software-based solutions, such as digital rights management designs, rely on obfuscation for protection of the decryption technologies. With software-based solutions, the policies are easy and inexpensive to renew, but such systems can be easier to compromise in comparison to hardware-based designs. Smartcard based systems rely on a secure microprocessor.

The user may control the operation of the media recorder 400 through control signals provided on the exterior of the media recorder 400 housing through integrated user input interface 432. The media recorder 400 may be controlled using control signals originating from a remote control, which are received through the remote signals interface 434, in a conventional fashion.

Smart cards can be inexpensively replaced, but have proven easier to attack than the embedded hardware solutions. During playback operation, an instruction may be received to accelerate—“fast-forward”—the effective frame rate of the recorded content signal stream being played. The apparent increase in frame rate is generally accomplished by periodically reducing the number of content frames that are displayed. Typically, multiple acceleration rates may be enabled, providing display at multiple fast-forward speeds. An accelerated display of a video signal recorded at a standard rate, such as thirty frames per second, may display the video at effectively higher frame rates although the actual rate the frames are displayed does not change.

Other conventional electronic input devices may also be provided for enabling user input to media recorder 400, such as a keyboard, touch screen, mouse, joy stick, or other device. These devices may be built into media recorder 400 or associated hardware (e.g., a video display, audio system, etc.), be connected through conventional ports (e.g., serial connection, USB, etc.), or interface with a wireless signal receiver (e.g., infrared, Bluetooth.TM., 802.11b, etc.).

For example, where a digital video recorder 108 includes three fast-forward settings, the fast-forward frame rates may appear to be 60 frames per second, 90 frames per second and 120 frames per second. The remote control used to control a media recorder may be a personal remote, where data sent from the remote control to the digital video recorder identifies the person associated with the remote control device. Where an authentication process has been used to authenticate the personal remote, the use of the personal remote could provide a legally binding signature for interactions, including any commercial transactions. In accordance with an embodiment, the personal remote could be a cellular telephone, personal digital assistant, or any other appropriate personal digital device.

A graphical interface module 444 provides graphical interfaces on a display to permit user selections to be entered. The audiovisual input module 402 receives input through an interface module 418 that may include various conventional interfaces, including coaxial RF/Ant, S-Video, component audio/video, network interfaces, and others. The received signals can originate from standard NTSC broadcast, high definition television broadcast, standard cable, digital cable, satellite, Internet, or other sources, with the audiovisual input module 402 being configured to include appropriate conventional tuning and decoding functionality.

An integrated personal remote with a microphone and camera, such as might be found on a cellular phone, could be used for live interaction through the media recorder system with product representatives or other interactions. A personal remote could communicate wirelessly with the media system using I/R, radio communications, etc. A docking station could be used to directly connect the portable device to the system. An interface port, such as a USB port, may be built into the portable communication device for direct connection to a digital video recorder, content receiver or any networked device.

The media recorder 400 may also receive input from other devices, such as a set top box or a media player (e.g., VCR, DVD player, etc.). For example, a set top box might receive one signal format and outputs an NTSC signal or some other conventional format to the media recorder 400. The functionality of a set top box, media player, or other device may be built into the same unit as the media recorder 400 and share one or more resources with it.

Where product viewings, purchases and identity are associated and logged, demographic and habit patterns could be provided to advertisers, product suppliers and other interested parties. Using this data collection, personalized recommendations could be provided to the identified user. In accordance with the practices of persons skilled in the art of computer programming, there are descriptions referring to symbolic representations of operations that are performed by a computer system or a like electronic system. Such operations are sometimes referred to as being computer-executed.

The audiovisual input module 402 may include an encoding module 436. The encoding modules 436 convert signals from a first format (e.g., analog NTSC format) into a second format (e.g., MPEG 2, etc.) so that the signal converted into the second format may be stored in the memory 408 or the data storage medium 410 such as a hard disk. Typically, content corresponding to the formatted data stored in the data storage medium 410 may be viewed immediately, or at a later time.

It will be appreciated that operations that are symbolically represented may include the manipulation by a processor, such as a central processing unit, of electrical signals representing data bits and the maintenance of data bits at memory locations such as in system memory, as well as other processing of signals. The memory locations where data bits are maintained may be physical locations that have particular electrical, magnetic, optical, or organic properties corresponding to the data bits. Thus, the term “server” may be understood to include any electronic device that contains a processor, such as a central processing unit. When implemented in software, processes may be embodied essentially as code segments to perform the necessary tasks.

Additional information may be stored in association with the media data to manage and identify the stored programs. Other embodiments may use other appropriate types of compression. The audiovisual output module 408 may include an interface module 422, a graphics module 424, video decoder 428 and audio decoder 426. The video decoder 428 and audio decoder 426 may be MPEG decoders.

The program or code segments may be stored in a processor readable medium or transmitted by a computer data signal embodied in a carrier wave over a transmission medium or communication link. The “processor readable medium” may include any medium that can store or transfer information. Examples of the processor readable medium include an electronic circuit, a semiconductor memory device, a ROM, a flash memory or other non-volatile memory, a floppy diskette, a CD-ROM, an optical disk, a hard disk, a fiber optic medium, a radio frequency (RF) link, etc.

The video decoder 428 may obtain encoded data stored in the data storage medium 410 and convert the encoded data into a format compatible with the display device 430. Typically the NTSC format may be used as such signals are displayed by a conventional television set. The graphics module 424 may receive guide and control information and provides signals for corresponding displays, outputting them in a compatible format.

The computer data signal may include any signal that can propagate over a transmission medium such as electronic network channels, optical fibers, air, electromagnetic, RF links, etc. The code segments may be downloaded via computer networks such as the Internet, Intranet, etc. Telecommunication systems distribute content objects. Various systems and methods utilize a number of content object entities that can be sources and/or destinations for content objects. A combination of abstraction and distinction engines can be used to access content objects from a source of content objects, format and/or modify the content objects, and redistribute the modified content object to one or more content object destinations.

The audio decoder 426 may obtain encoded data stored in the data storage medium 410 and converts the encoded data into a format compatible with an audio rendering device 436. The media recorder 400 may process guide information that describes and allows navigation among content from a content provider at present or future times. The guide information may describe and allow navigation for content that has already been captured by the media recorder 400.

In some cases, an access point is included that identifies a number of available content objects, and identifies one or more content object destinations to which the respective content objects can be directed. Such systems and methods can be used to select a desired content object, and to select a content object entity to which the content object is directed. In addition, the systems and methods can be used to modify the content object as to format and/or content. For example, the content object may be reformatted for use on a selected content object entity, modified to add additional or to reduce the content included in the content object, or combined with one or more other content objects to create a composite content object.

Guides that display this type of information may generally be referred to as content guides. A content guide may include channel guides and playback guides. A channel guide may display available content from which individual pieces of content may be selected for current or future recording and viewing. In a specific case, the channel guide may list numerous broadcast television programs, and the user may select one or more of the programs for recording.

This composite content object can then be directed to a content object destination where it can be either stored or utilized. Abstraction and distinction processes may be performed on content objects. These systems may include an abstraction engine and a distinction engine. The abstraction engine may be communicably coupled to a first group of content object entities, and the distinction engine may communicably coupled to second group of content object entities. The two groups of content object entities are not necessarily mutually exclusive, and in many cases, a content object entity in one of the groups is also included in the other group.

The playback guide displays content that is stored or immediately storable by the media recorder 400. Other terminology may be used for the guides. For example, they may be referred to as programming guides or the like. The term content guide is intended to cover all of these alternatives. The media recorder 400 may also be referred to as a digital video recorder or a personal video recorder.

The first of the groups of content object entities may include content objects entities such as an appliance control system, a telephone information system, a storage medium including video objects, a storage medium including audio objects, an audio stream source, a video stream source, a human interface, the Internet, and an interactive content entity. The second group of content object entities may include content object entities such as an appliance control system, a telephone information system, a storage medium including video objects, a storage medium including audio objects, a human interface, the Internet, and an interactive content entity. In some instances, two or more of the content object entities are maintained on separate partitions of a common database.

Although certain modular components of a media recorder 400 are shown in FIG. 4, the present invention also contemplates and encompasses units having different features. For example, some devices may omit a telephone line modem, instead using alternative conduits to acquire guide data or other information used in practicing the present invention. Additionally, some devices may add features such as a conditional access module 442, such as one implementing smart card technology, which works in conjunction with certain content providers or broadcasters to restrict access to content.

In such instances, the common database can be partitioned using a content based schema, while in other cases the common database can be partitioned using a user based schema. In particular instances, the abstraction engine may be operable to receive a content object from one of the groups of content object entities, and to form the content object into an abstract format. As just one example, this abstract format can be a format that is compatible at a high level with other content formats. In other instances, the abstraction engine is operable to receive a content object from one of the content object entities, and to derive another content object based on the aforementioned content object.

Additionally, although this embodiment and other embodiments of the present invention are described in connection with an independent media recorder device, the descriptions may be equally applicable to integrated devices including but not limited to cable or satellite set top boxes, televisions or any other appropriate device capable of including modules to enable similar functionality.

Further, the abstraction engine can be operable to receive yet another content object from one of the content object entities and to derive an additional content object there from. The abstraction engine can then combine the two derived content objects to create a composite content object. In some cases, the distinction engine accepts the composite content object and formats it such that it is compatible with a particular group of content object entities. In yet other instances, the abstraction engine is operable to receive a content object from one group of content object entities, and to form that content object into an abstract format.

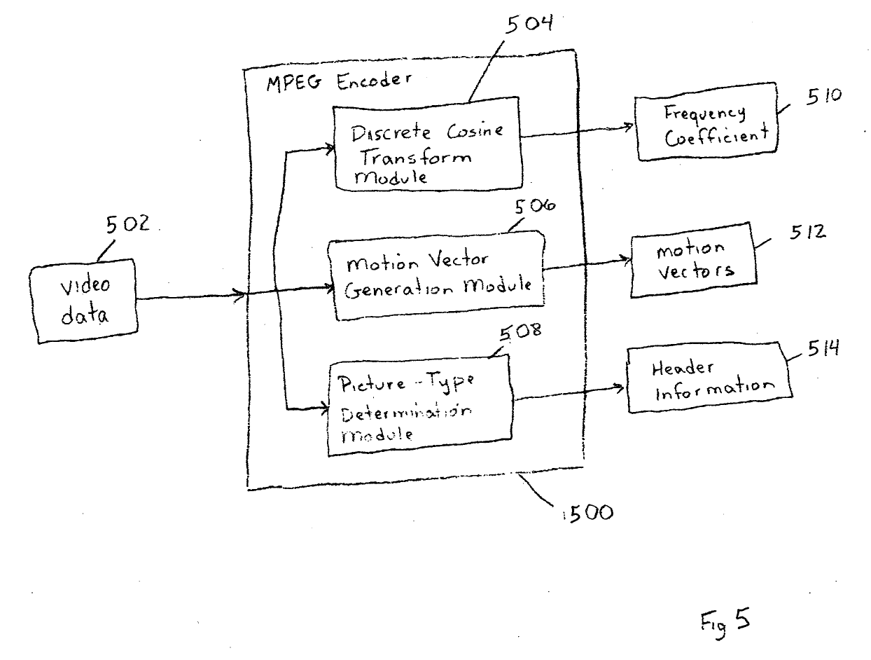

With reference to FIG. 5, an MPEG encoder 500 is shown. MPEG encoder 500 receives video data 502. Video data 502 may be formed from a sequence of video images. MPEG encoder 500 typically includes a discrete cosine transform module 504, a motion vector generation module 506 and a picture type determination module 508. The component modules separate video data 504 into different requisite parts.

The distinguishing engine can then conform the abstracted content object with a standard compatible with a selected one of another group of content object entities. In some other instances, the systems include an access point that indicates a number of content objects associated with one group of content object entities, and a number of content objects associated with another group of content object entities. The access point indicates from which group of content object entities a content object can be accessed, and a group of content object entities to which the content object can be directed.

The discrete cosine transform module 504 transforms blocks of the video data from the spatial domain into a frequency domain representation of the same blocks. Motion vector generation module 502 generates motion vectors representing motion between macroblock regions in the frames of video data 502. Picture type determination module 508 determines the frames that should be used as reference frames (I-frames).

Methods for utilizing content objects may include accessing a content object from a content object entity; abstracting the content object to create an abstracted content object; distinguishing the abstracted content object to create a distinguished content object, and providing the distinguished content object to a content object entity capable of utilizing the distinguished content object. In some cases, the methods further include accessing yet another content object from another content object entity, and abstracting that content object entity to create another abstracted content object entity.

The encoded MPEG video bit stream may include frequency coefficients 510, motion vectors 512, and header information 514 to specify size, picture coding type, etc.

The two abstracted content object entities can be combined to create a composite content object entity. In one particular case, the first abstracted content object may be a video content object and the second abstracted content object may be an audio content object. Thus, the composite content object includes audio from one source, and video from another source. Further, in such a case, abstracting the video content object can include removing the original audio track from the video content object prior to combining the two abstracted content objects. As yet another example, the first abstracted content object can be an Internet object, while the other abstracted content object is a video content object.

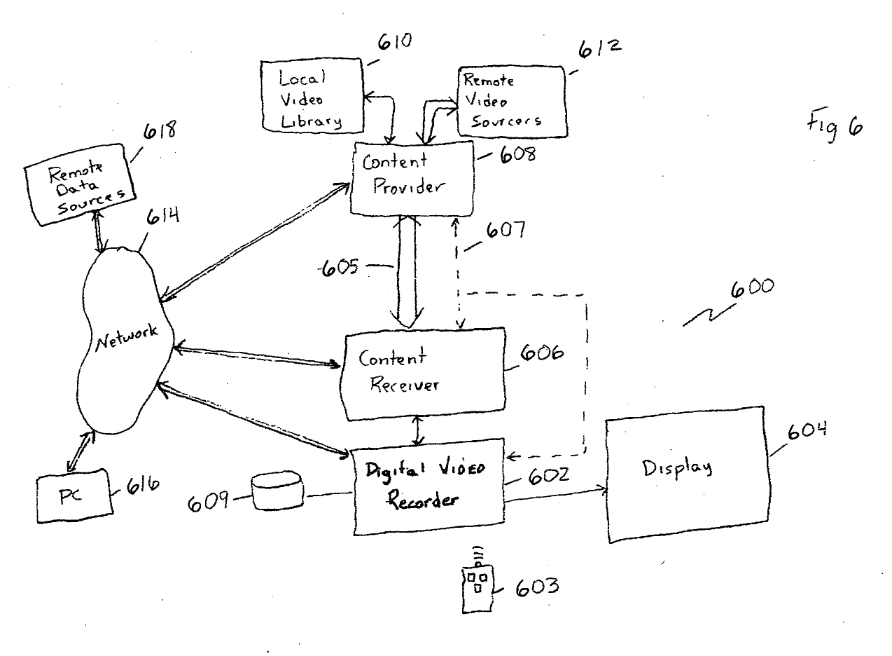

With reference to FIG. 6, a video distribution system 600 is shown. Content signal streams representing video, audio, images, television programming, movies, text, software or any other appropriate media content, are transmitted from content provider 608 to content receiver 606 over a communications network 605. Content provider 608 may typically be cable television providers, satellite television providers or other media broadcast source.

In other cases, the methods can further include identifying a content object associated with one group of content object entities that has expired, and removing the identified content object. Other cases include querying a number of content object entities to identify one or more content objects accessible via the content object entities, and providing an access point that indicates the identified content objects and one or more content object entities to which the identified content objects can be directed. Methods may include accessing content objects within a customer premises.

The content receiver 606 typically provides authentication for conditional access content, descrambles, decodes or otherwise processes the received content signal streams. The content receiver 606 may be a set-top box such as a cable or satellite receiver. The content receiver 606 provides processed content signal streams to a media recorder 602.

Such methods may include identifying content object entities within the customer premises, and grouping the identified content objects into two or more groups of content object entities. At least one of the groups of content object entities may include sources of content objects, and at least another of the groups of content object entities may include destinations of content objects. The methods may include providing an access point that indicates the at least one group of content object entities that can act as content object sources, and at least another group of content object entities that can act as content object destinations.

The media recorder may be implemented as a digital video recorder, as an independent unit or integrated into another media unit, a personal video recorder, a general purpose computer programmed to enable the functions of a media recorder, or any other appropriate recording system. In accordance with programming provided as inputs to remote control 603, usually in conjunction with interactive menus displayed on display 604, the media recorder records specified content signal streams on storage device 609.

In some cases, the methods further include mixing two or more content objects from the first plurality of content object entities to form a composite content object, and providing the composite content object to a content object entity capable of utilizing it. In other cases, the methods further include eliminating a portion of a content object accessed from one group of content object entities and providing this reduced content object to another content object entity capable of utilizing the reduced content object entity.

The content receiver 606 may be physically integrated with the digital recorder 602. The digital video recorder 602 may pass live content signal streams to display 604. The media recorder 602 may record the live content signal stream on memory device 609 and decode the recorded live content signal stream for immediate playback. The media recorder 602 may decode and deliver recorded content signal streams to the display 604 on request. Exchanges of data may take place between digital video recorder 602 and content provider 608.

A variety of digital video compression techniques have arisen to transmit or to store a video signal with a lower data rate or with less storage space. Such video compression techniques include international standards, such as H.261, H.263, H.263+, H.263++, H.264, MPEG-1, MPEG-2, MPEG-4, and MPEG-7. These compression techniques achieve relatively high compression ratios by discrete cosine transform (DCT) techniques and motion compensation (MC) techniques, among others.

The exchange of data may take place over communications network 605, back-channel 607, network 614 or any other appropriate communication channel. Typically, media broadcast schedule data including the time, channel and title of televised broadcasts may be delivered from the content provider 608 to the digital video recorder 602. The media recorder may use the media broadcast schedule data to schedule recordings.

Such video compression techniques permit video data streams to be efficiently carried across a variety of digital networks, such as wireless cellular telephony networks, computer networks, cable networks, via satellite, and the like, and to be efficiently stored on storage mediums such as hard disks, optical disks, Video Compact Discs (VCDs), digital video discs (DVDs), and the like. The encoded data streams are decoded by a video decoder that is compatible with the syntax of the encoded data stream. For relatively high image quality, video encoding can consume a relatively large amount of data.

The media broadcast schedule data may be retrieved from remote data sources 618 connected to network 614. The communication may be made through the video transmission connection via the content receiver 606 or along an alternate communication path 607 such as a telephone connection or a network connection, depending on the specific requirements and capabilities of the embodiment.

However, the communication networks that carry the video data can limit the data rate that is available for encoding. For example, a data channel in a direct broadcast satellite (DBS) system or a data channel in a digital cable television network typically carries data at a relatively constant bit rate (CBR) for a programming channel. In addition, a storage medium, such as the storage capacity of a disk, can also place a constraint on the number of bits available to encode images.

A computer 616 may be communicably connected to media recorder 602. Computer 616 may be local to the media recorder, directly connected or connected through a local network. Computer 616 may be remote to the media recorder, connected through the Internet. Computer 616 may be used as an input device to the media recorder system. Computer 616 may be used as an output device for the media recorder system.

As a result, a video encoding process often trades off image quality against the number of bits used to compress the images. Moreover, video encoding can be relatively complex. For example, where implemented in software, the video encoding process can consume relatively many CPU cycles. Further, the time constraints applied to an encoding process when video is encoded in real time can limit the complexity with which encoding is performed, thereby limiting the picture quality that can be attained.

Content provider 608 may access content files for distribution from local video libraries 610 or from remote video libraries 612. The video libraries 610 or 612 may be fiscally integral with the content providers or may be out-sourced. Content provider 608 may receive or otherwise generate a listing of the video presentations available in the video libraries 610 and 612.

One conventional method for rate control and quantization control for an encoding process is described in Chapter 10 of Test Model 5 (TM5) from the MPEG Software Simulation Group (MSSG). TM5 suffers from a number of shortcomings. An example of such a shortcoming is that TM5 does not guarantee compliance with the Video Buffer Verifier (VBV) requirement. As a result, overrunning and underrunning of a decoder buffer can occur, which undesirably results in the freezing of a sequence of pictures and the loss of data.

The listings may include information regarding the video presentations as reference data for the viewer and to facilitate searching or organization of the video presentations to provide ease of selection. The listing may be provided to the digital video recorder 602 by any of the communication paths.

In accordance with the MPEG-2 standard, video data may be compressed based on a sequence of groups of pictures (GOPs), made up of three types of picture frames—intra-coded picture frames (“I-frames”), forward predictive frames (“P-frames”) and bilinear frames (“B-frames”). Each GOP may, for example, begin with an I-frame which is obtained by spatially compressing a complete picture using discrete cosine transform (DCT). As a result, if an error or a channel switch occurs, it is possible to resume correct decoding at the next I-frame.

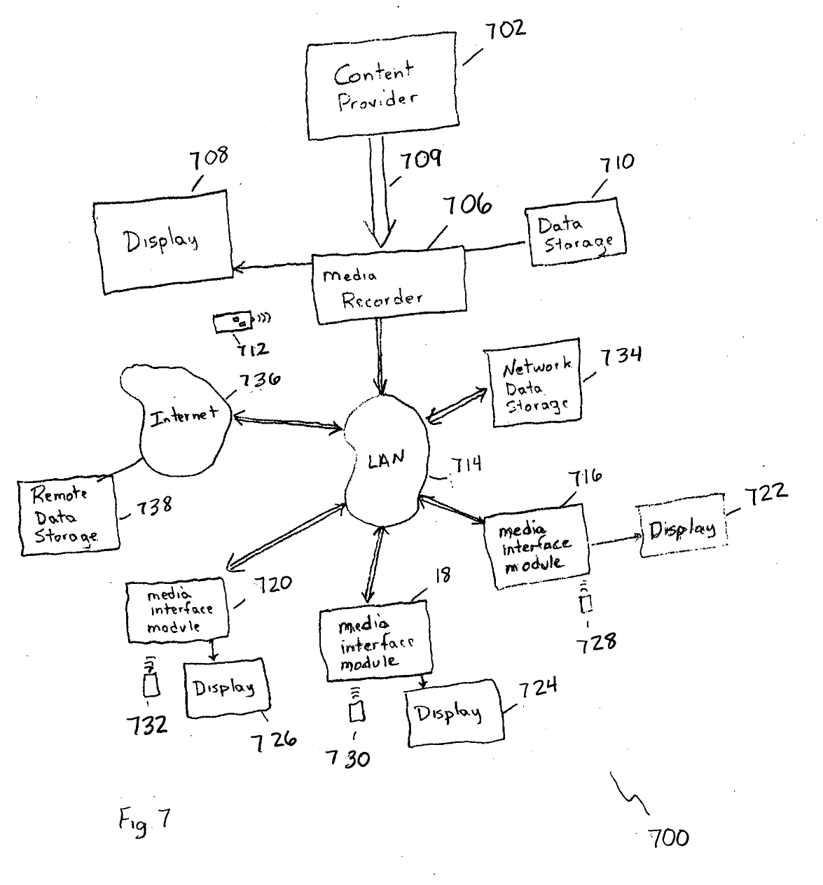

With reference to FIG. 7, a media interface module system 700 is shown. A content provider 702 sends content signal streams to a content recorder 706 on communications network 709. A media recorder 706, in accordance with user-input instructions provided using an input device 712, such as a remote control, records content signal streams on data storage 710.

The GOP may represent additional frames by providing a much smaller block of digital data that indicates how small portions of the I-frame, referred to as macroblocks, move over time. An I-frame is typically followed by multiple P- and B-frames in a GOP. Thus, for example, a P-frame occurs more frequently than an I-frame by a ratio of about 3 to 1. A P-frame is forward predictive and is encoded from the I- or P-frame that precedes it. A P-frame contains the difference between a current frame and the previous I- or P-frame. A B-frame compares both the preceding and subsequent I- or P-frame data.

A listing of the recorded content signal streams on data storage 710 may be stored on data storage device 710, network data storage 734 or remote data storage 738, for example connected through Internet 736. The media recorder 706 may deliver media content to a display 708. The media recorder 706 may cause interface screens to be displayed on display 708 to facilitate the input of user instructions.

The B-frame contains the average of matching macroblocks or motion vectors. Because a B-frame is encoded based upon both preceding and subsequent frame data, it effectively stores motion information. Thus, MPEG-2 achieves its compression by assuming that only small portions of an image change over time, making the representation of these additional frames extremely compact. Although GOPs have no relationship between themselves, the frames within a GOP have a specific relationship which builds off the initial I-frame.

The media interface module system 700 may include a local area network 714 to provide communication between the components. Other forms of network communication could be implemented. The local area network 714 provides interconnection between the media recorder and several dispersed media interface modules 716, 718 and 720. Each of the media interface modules 716, 718 and 720 may be connected to local displays 722, 724 and 726.

The compressed video and audio data are carried by continuous elementary streams, respectively, which are broken into access units or packets, resulting in packetized elementary streams (PESs). These packets are identified by headers that contain time stamps for synchronizing, and are used to form MPEG-2 transport streams. For digital broadcasting, multiple programs and their associated PESs are multiplexed into a single transport stream.

The media interface modules 716, 718, 720 may cause interface screens to be displayed on displays 722, 724 and 726 to facilitate the input of user instructions with input devices 728, 730 and 732. The media interface modules 716, 718 and 720 may display requested recorded content signal streams.

A transport stream has PES packets further subdivided into short fixed-size data packets, in which multiple programs encoded with different clocks can be carried. A transport stream not only comprises a multiplex of audio and video PESs, but also other data such as MPEG-2 program specific information (sometimes referred to as metadata) describing the transport stream.

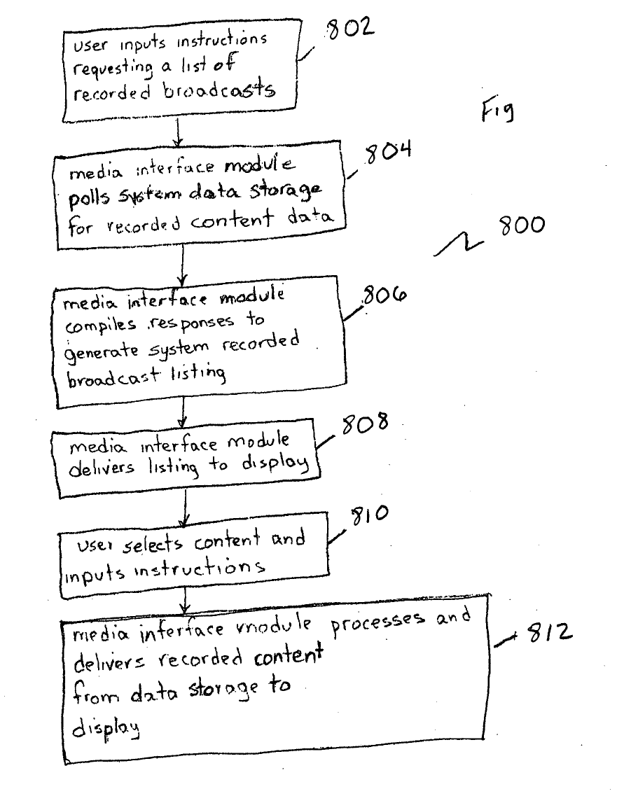

With reference to FIG. 8, a flowchart of a media interface module system playback process 800 is shown. At function block 802, a user inputs instructions to request a list of accessible recorded broadcasts. At function block 804, the media interface module polls the system data storage for recorded content data.

The MPEG-2 metadata may include a program associated table (PAT) that lists every program in the transport stream. Each entry in the PAT points to an individual program map table (PMT) that lists the elementary streams making up each program. Some programs are open, but some programs may be subject to conditional access (encryption) and this information is also carried in the MPEG-2 transport stream, possibly as metadata.

The available system data storage systems reply with the recorded content available on each data storage and the media interface module compiles the content data at function block 806. The media interface module delivers the compiled listing to the user on a display at function block 808. The user selects a broadcast from the compiled listing for playback and inputs instructions accordingly at function block 810.

The aforementioned fixed-size data packets in a transport stream each carry a packet identifier (PID) code. Packets in the same elementary streams all have the same PID, so that a decoder can select the elementary stream(s) it needs and reject the remainder. Packet-continuity counters may be implemented to ensure that every packet that is needed to decode a stream is received.

The media interface module delivers the selected content to a display device at function block 812. Because the media interface modules compile an up-to-date listing of the available recorded content each time a listing is requested, the listing will only reflect the files on the system memory devices that are on-line at that time. Specific system memory devices may be reserved for playback via specified media interface modules, to limit or control access to content. For example, adult content may only be playable using the media interface module in the master bedroom.

Content signals may be or include any one or more video signal formats, for instance NTSB, PAL, Windows.TM. AVI, Real Video, MPEG-2 or MPEG-4 or other formats, digital audio for instance in .WAV, MP3 or other formats, digital graphics for instance in .JPG, .BMP or other formats, computer software such as executable program files, patches, updates, transmittable applets such as ones in Java.TM. or other code, or other data, media or content.

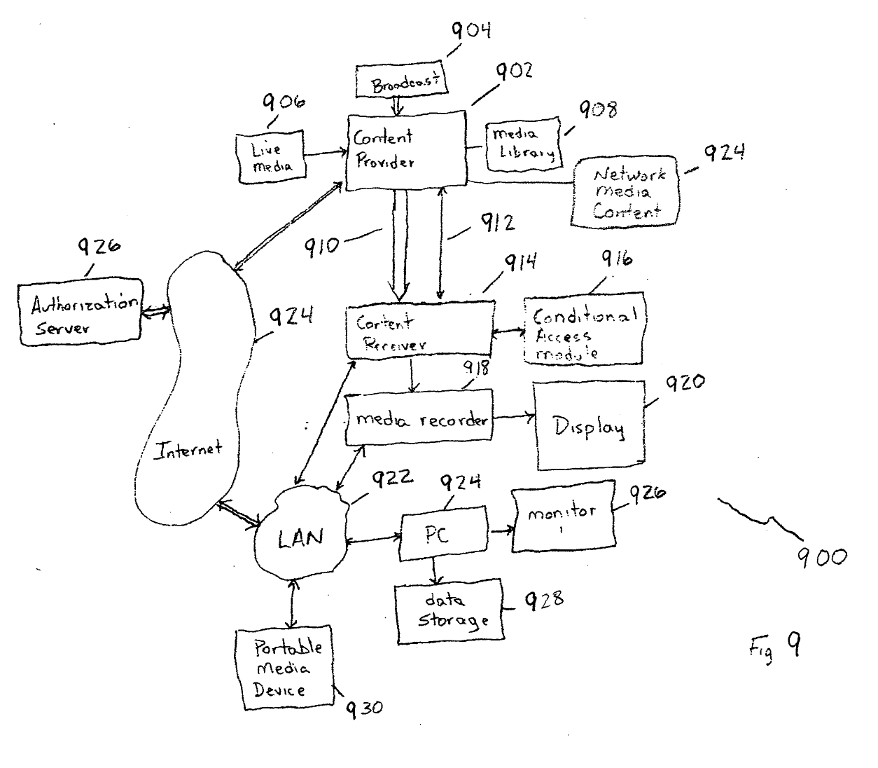

With reference to FIG. 9, a network media transfer system 900 is shown. A content provider 902 delivers media to a content receiver 914 over a communication system 910. The content provider may deliver live media content 906, broadcast media content 904, stored media content 908, network media content 924, or any other appropriate content.

The content receiver 914 may communicate with content provider 902 using a backchannel 912 such as a telephone connection, network connection or any other appropriate communication channel. A backchannel 912 is often used when communication system 910 is unidirectional, such as in a satellite broadcast system. Content receiver 914 may be connected to or otherwise implement a conditional access module 916.

Conditional access module 916 determines authorization and decodes encoded media signals accordingly. A media recorder 918 may receive media signals from content receiver 914. The media recorder 918 may store the media signals to data storage. The media recorder may deliver media signals to display 920 for viewing. A local area network 922 may connect the content receiver 914 and the media recorder 918 to other local devices as well as the Internet 924.

An authorization server 926 may provide authorization services to the media recorder 918. A personal computer 924 may be connected to the local area network 922. The personal computer 924 may received media signals from media recorder 918. The personal computer 924 may display the received media signals on a monitor 926.

The personal computer 924 may save the media signals on a data storage device 928 such as a hard drive or write-able optical disc. A portable media device 930 may be connected to the media recorder 918 by local area network 922. The portable media device 930 may receive media signals from media recorder 918 for viewing on an integrated display. The authorization server 926 may be used to authorize the distribution or playback of media signals sent from the media recorder 918 to other devices.

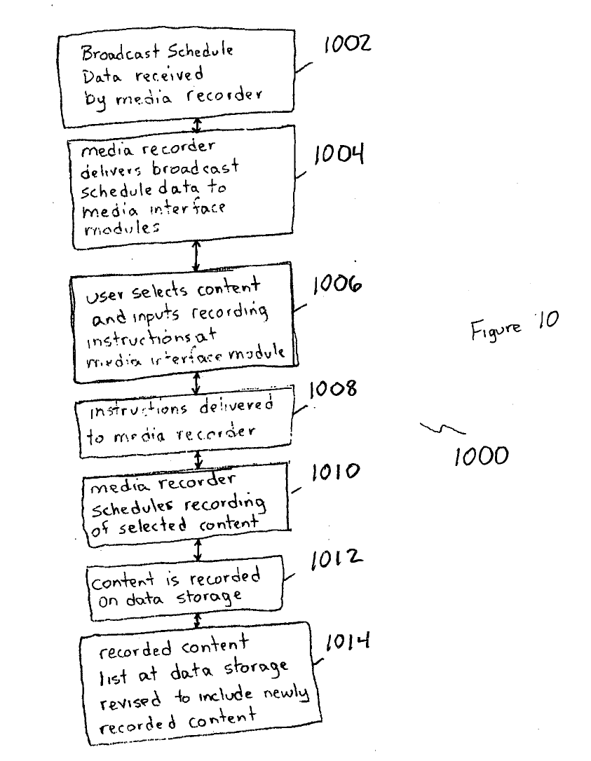

With reference to FIG. 10, a flowchart of a media interface module system recording process 1000 is shown. A current programming guide is delivered to a media recorder at function block 1002. The programming guide data is disseminated by the media recorder to the dispersed media interface modules at function block 1004.

A user selects a broadcast for recording from the current programming guide and enters recording instructions using a media interface module at function block 1004. The recording instructions are transmitted to the media recorder interface module at function block 1008. The media recorder may select a data storage device to store the selected broadcast data according to a programmed memory prioritization protocol at function block 1010.

When the selected broadcast is transmitted from the content provider, the selected broadcast data is recorded on the data storage device at function block 1012. The data storage device recorded broadcast list is revised at function block 1014 to include data regarding the recorded selected broadcast data.

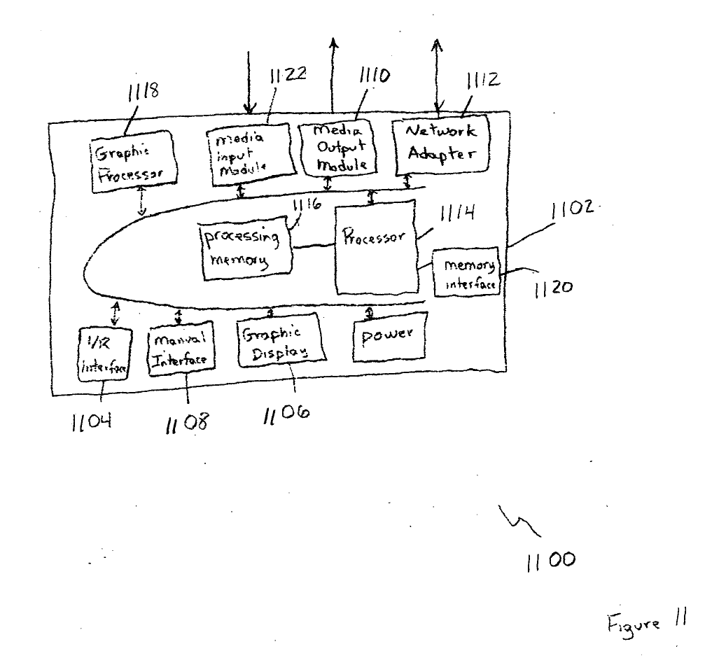

With reference to FIG. 11, a functional block diagram of a media recorder interface device 1100 is shown. Media recorder interface module 1100 typically includes a housing 1102 with an I/R interface 1104 for receiving input signals from a remote control. The housing 1102 may include a visual display 1106 such as LEDs, LCD screens or other appropriate visual displays.

The housing 1102 may include other input devices 1108 such as buttons or other appropriate input mechanisms. he media recorder interface module 1100 may include a media input module 1108 for receiving content signal streams. The media recorder interface module 1100 may include a local network interface 1112 for connecting the media recorder interface module 1100 to a local communication network.

A local communication network may be any type of network, including, but not limited to, Ethernet, HomePNA, wireless (e.g., 802.11a, 802.11b, 802.11g), and powerline. A processor 1114, in conjunction with processing memory 1116, executes software to manage the interfaces, media handling and instruction exchanges.

The media recorder interface module 1100 may include a memory interface module 1120 to directly connect data storage to the media recorder interface module 1100. A graphic processor 1118 may perform local graphic processing to the content signals delivered. The processed media may be delivered to media output module 1110, typically to be rendered on a display for viewing.

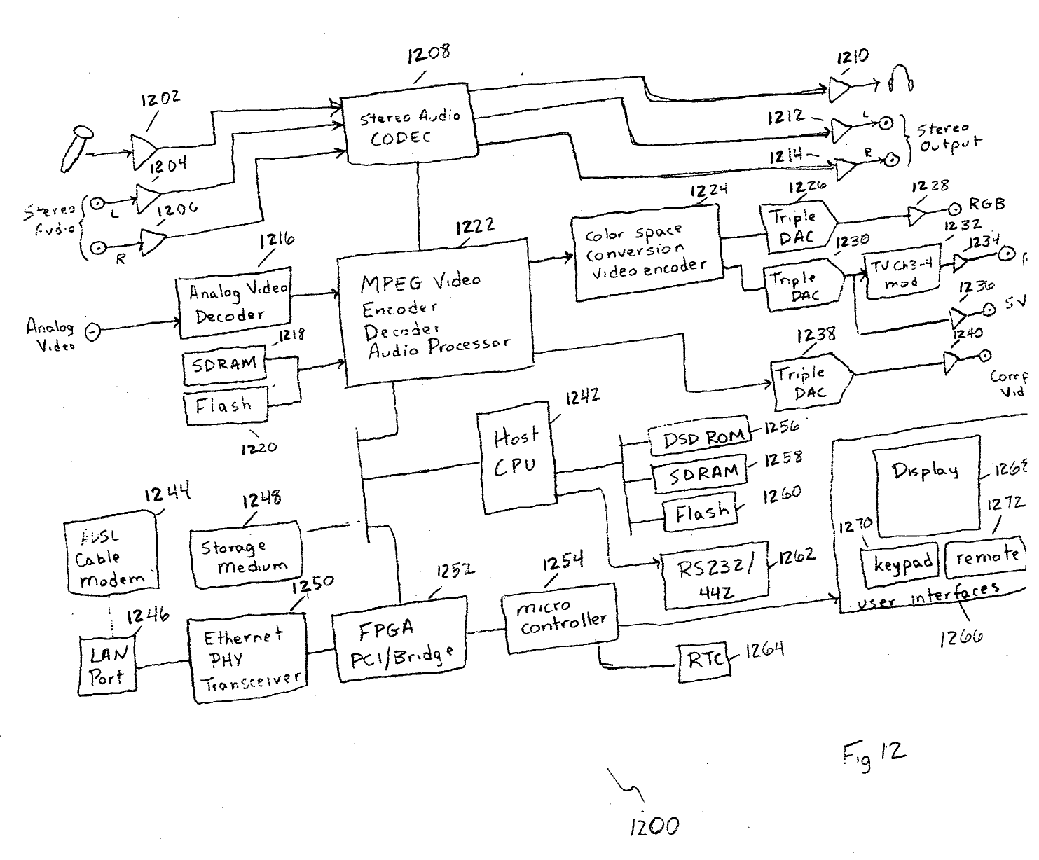

With reference to FIG. 12, a functional block diagram of a media recorder 1200 is shown. An analog video signal may be delivered to an analog video decoder 1216. The analog video decoder 1216 digitizes and decodes baseband analog video formats (NTSC/PAL/SECAM) into digital component video and delivers the decoded video signal to MPEG video encoder decoder audio processor 1222.

The MPEG processor 1222 may receive data from memory units, such as SDRAM 1218 and Flash memory 1220. The MPEG processor may deliver an encoded video signal to a color space conversion video encoder 1224. The color space conversion video encoder 1224 may provide an encoded video signal to triple digital to analog converter 1226.

The triple DAC 1226 converts digital video into analog video output in different formats: NTSC/PAL, S video, and YPrPb component video. The output stages require high-performance op-amps to amplify the video signals and may provide an RGB signal to amplifier 1228 for output to a rendering device. The color space conversion video encoder 1224 may provide an encoded video signal to triple DAC 1230 to provide a modulated RF signal from RF modulator 1232.

The output of the RF modulator 1232 is delivered to amplifier 1234 for output to a rendering device. The output video signal of triple DAC 1230 may be provided to amplifier 1236 for output to a rendering device as a composite S-Video signal. MPEG processor 1222 may provide a content signal to a triple DAC 1238 for ouput to amplifier 1240, generate a component media signal.

MPEG processor 1222 may be connected to a host processor 1242. The host processor 1242 controls the DVR operating system software, overlay of text/graphics, and the user interface and may receive data from memory units such as DSD ROM 1256, SDRAM 1258 or flash memory 1260. An RS232/442 1262 connection may be provided to the host processor 1242. The host processor 1242 and MPEG processor 1222 may store and read data from storage medium 1248.

An ADSL Cable modem 1244 may provide network connectivity to the media recorder 1200. The modem 1244 may be connected to a LAN port 1246. An Ethernet PHY transceiver 1250, communicably connected to the LAN port 1246 communicates with FPGA PCI/Bridge 1252. FPGA PCI/Bridge 1252 provides data/command transfer between devices connecting to the PCI bus.

A microcontroller 1254, connected to the FPGA PCI/Bridge 1252, connects to the user interfaces 1266 and RTC 1264. Audio input from a microphone or stereo output is amplified at amplifiers 1202, 1204 and 1206. The amplified signals are provided to a stereo audio codec 1208. The stereo audio codec 1208 uses audio ADC and DAC to digitize and playback analog audio, decoding the audio signals for output via amplifiers 1210, 1212 and 1214.

The user interfaces 1266 may include a display 1268, a keypad 1270, an I/R remote control 1272 or other appropriate interface systems and devices.

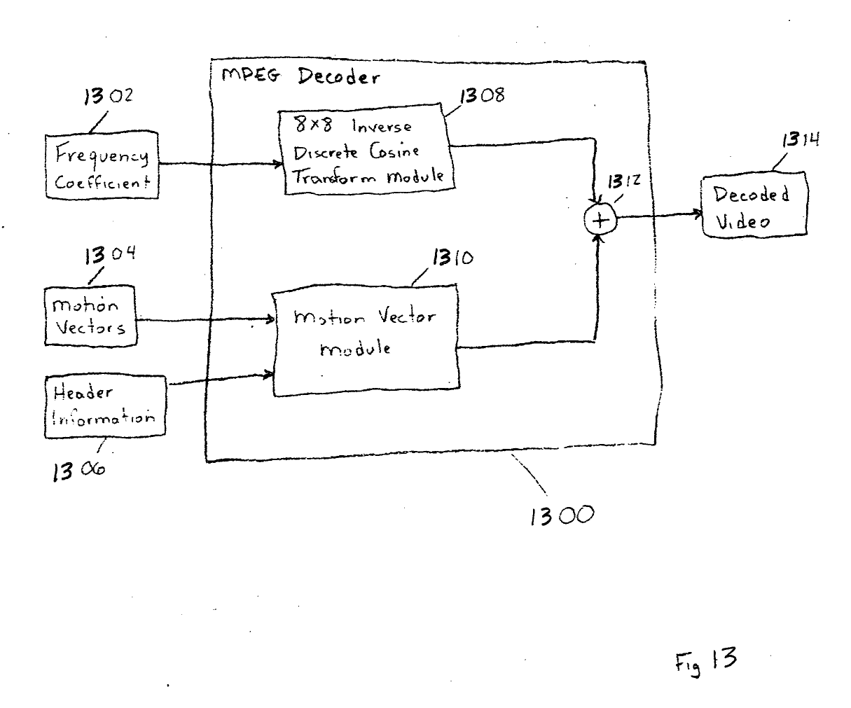

With reference to FIG. 13, an MPEG decoder 1300 is shown. To reconstruct the original sequence of video images from the encoded signals, inverse operations are performed. Frequency coefficients 1302 are dequantized and passed though inverse discrete cosine transform module 1308, converting them back into spatial domain representations.

Motion vector module 1310 uses header information 1306 and motion vectors 1304 to recreate the macroblocks of P-frames and B-frames. The outputs from inverse discrete cosine transform module 1308 and motion vector module 1310 are then summed by summer 1312 to generate reconstructed output 1314. Reconstructed output 1314 is a sequence of video images similar to the video signal that was encoded and can be displayed on a display device.

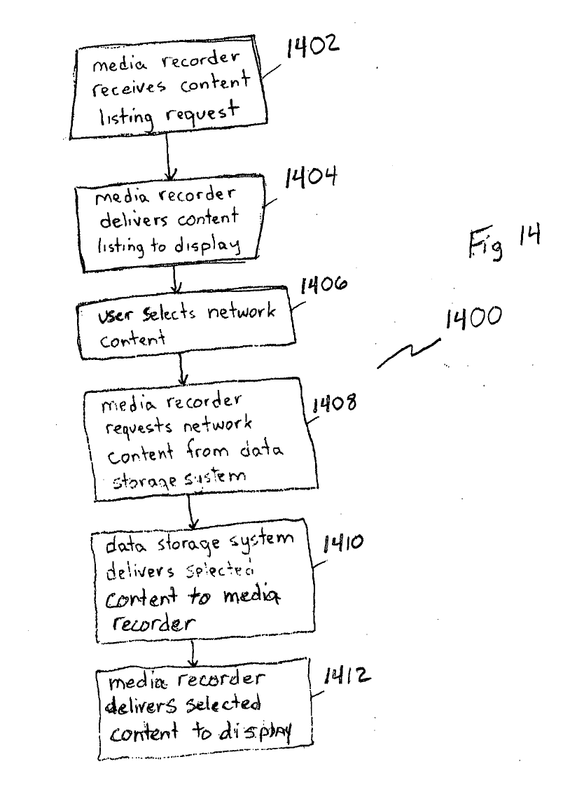

With reference to FIG. 14, a process of delivering network media content is shown. A media recorder receives a content listing request from a user at function block 1402. The media recorder assembles, generates or otherwise delivers content listing to a display at function block 1404. A user selects content stored on a local network device at function block 1406.

The media recorder requests the selected content from the data storage system storing the selected content at function block 1408. The data storage system delivers selected content to the media recorder at function block 1410. The media recorder delivers the selected content to a display at function block 1412.

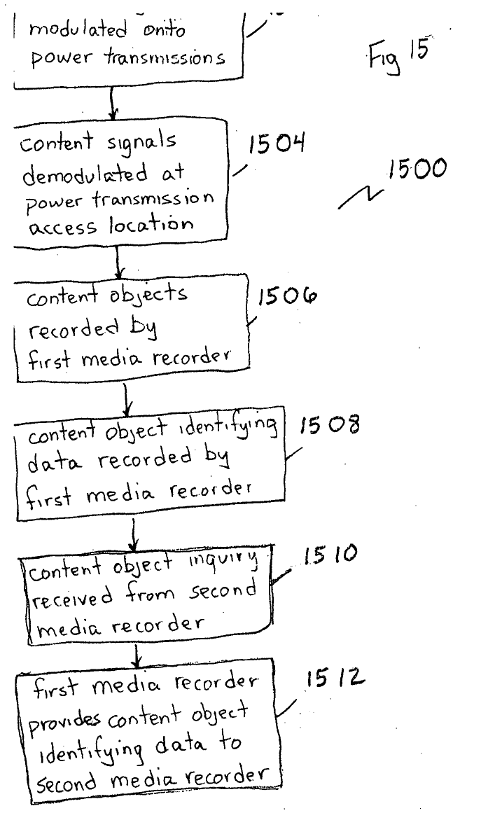

With reference to FIG. 15, a power grid content distribution method 1500 is shown. Content signals are modulated onto a power transmission at function block 1502. The content signals are demodulated at a power grid access location to generate content objects at function block 1504. A media recorder receives and records selected content objects at function block 1506.

The media recorder generates and records content object identifying data at function block 1508. The content object identifying data may typically include a title and file location data. A second media recorder communicably connected to the first media recorder generates a content object inquiry and the content object inquiry is provided to the first media recorder at function block 1510.

The first media recorder and the second media recorder may be communicably connected by a local area network, an Internet connection, by the power grid communication network or any other suitable communication connection system. The first media recorder provides content object identifying data to the second media recorder at function block 1512.

It will be appreciated by those skilled in the art having the benefit of this disclosure that this invention provides a personal video recorder interface device. It should be understood that the drawings and detailed description herein are to be regarded in an illustrative rather than a restrictive manner, and are not intended to limit the invention to the particular forms and examples disclosed. On the contrary, the invention includes any further modifications, changes, rearrangements, substitutions, alternatives, design choices, and embodiments apparent to those of ordinary skill in the art, without departing from the spirit and scope of this invention, as defined by the following claims. Thus, it is intended that the following claims be interpreted to embrace all such further modifications, changes, rearrangements, substitutions, alternatives, design choices, and embodiments.

What is claimed is:

1. A method of selecting broadcast recordings for playback on a personal video recorder interface system comprising the steps of:
receiving broadcast recordings at a personal video recorder module;
storing said broadcast recordings on a system memory device;
creating a data file including information regarding said broadcast recordings;
storing said data file on said system memory device;
requesting said data file from said system memory device by said personal video recorder interface module;
displaying broadcast recordings selected from said data file.
